(19) United States
(12) Patent Application Publication
(10) Pub. No.: US 2013/0164460 A1
(43) Pub. Date: Jun. 27, 2013

(54) PLANE STRUCTURE OF POLYMERIC DISPERSED LIQUID CRYSTAL FILM

(71) Applicant: Sam YU, Taoyuan City (TW)

(72) Inventor: Sam YU, Taoyuan City (TW)

(21) Appl. No.: 13/336,754

(22) Filed: Dec. 23, 2011

(51) Int. Cl. C09K 19/38

(52) U.S. Cl. 428/1.5

(57) ABSTRACT

A plane structure of polymeric dispersed liquid crystal (PDLC) film is provided. It includes two opposite transparent rigid substrates, and a PDLC light shuttle film arranged on the inner surface of one transparent rigid substrate. A sealed structure is formed on the periphery of the gap between two transparent rigid substrates to construct a sealed hollow space. This plane structure of PDLC film may change transparent state at user's own choice, and has the advantages of heat insulation and soundproofing.

### BACKGROUND OF THE INVENTION

1. Field of the Invention

The present invention relates to a plane structure of polymeric dispersed liquid crystal (PDLC) film, and particularly to a plane structure of polymeric dispersed liquid crystal (PDLC) film including two opposite transparent rigid substrates. A hollow and insulation design for a PDLC light shuttle film is arranged between the two transparent rigid substrates.

2. Description of the Prior Art

Transparent glass curtain walls are usually adopted for many modern designs of curtain walls, greenhouse, and partition walls or screen partitions for ornamental and lighting purposes. Besides, transparent glass curtains are usually arranged with window curtains, dyed glass design or insulation paper adhered. However, installation of window curtains occupies more space and must be maintained regularly; using dyed glass and insulation paper cannot control the amount of light passing through; insulation paper is usually stuck on the outside surface of glass curtain walls and easily becomes dirty and damaged.

Recent years a type of smart glass is developed, which is based on characteristics of crystal liquid materials installed within. The glass transparency can be adjusted by changing the electric current. However, this type of smart glass lacks functions for thermal insulation, vapor resistance, heat preservation, soundproofing and so on; the useful life is easily affected due to long-term sunlight exposure.

### SUMMARY OF THE INVENTION

The present invention is made in view of the above-mentioned states of the art and it is an object of the present invention to provide a plane structure of polymeric dispersed liquid crystal film which can change its transparency according to users' needs with the advantages of blocking sight from viewers outside and protecting privacy, wherein a hollow and insulation design of air spacer is applied to the gap between the PDLC light shuffle film and the transparent rigid substrate or between the transparent rigid substrates to make the plane structure better thermal-insulated. In addition to better safety, it also can form a constant temperature environment indoors with the advantage of energy saving.

One objective of the present invention is to provide a plane structure of polymeric dispersed liquid crystal film, which can be applied to construction industry regarding of doors and windows, glass curtain walls and screen partitions with nice performance of soundproofing, thermal insulation and vapor resistance.

In order to achieve the objectives described above, a plane structure of polymeric dispersed liquid crystal film according to one embodiment of the present invention comprises: two opposite transparent rigid substrates separately arranged, which are a first transparent rigid substrate and a second transparent rigid substrate; the first transparent rigid substrate and the second transparent rigid substrate respectively have a first inner surface and a second inner surface opposite to each other; a PDLC light shuffle film is arranged on the first inner face; a first sealed structure is arranged on the periphery between the first inner surface and the second inner surface, for forming a first hollow space between the first transparent rigid substrate and the second transparent rigid substrate.

According to another embodiment of the present invention, a plane structure of polymeric dispersed liquid crystal film comprises: two opposite transparent rigid substrates arranged separately; a sealed structure arranged on the periphery between the two transparent rigid substrates, whereof at least two opposite inner faces forming a groove; and a PDLC light shuffle film, whereof at least two opposite sides arranged in the groove, for arranging the PDLC light shuffle film between the two transparent rigid substrates.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram of a first plane structure of polymeric dispersed liquid crystal film according to a first embodiment of the present invention;

FIG. 2 is a partial cross section schematic diagram of a plane structure of polymeric dispersed liquid crystal film according to the first embodiment of the present invention;

FIG. 3 is a cross section schematic diagram of a plane structure of polymeric dispersed liquid crystal film according to a second embodiment of the invention;

FIG. 4 is a cross section schematic diagram of a plane structure of polymeric dispersed liquid crystal film according to a third embodiment of the present invention;

### DESCRIPTION OF THE PREFERRED EMBODIMENT

The detail description is provided below and the preferred embodiments described are only for the purpose of description rather than for limiting the present invention.

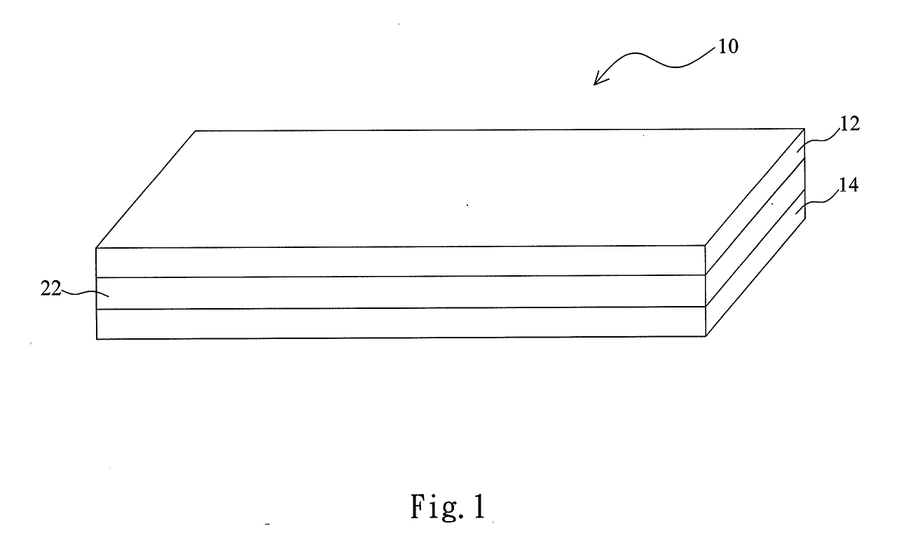

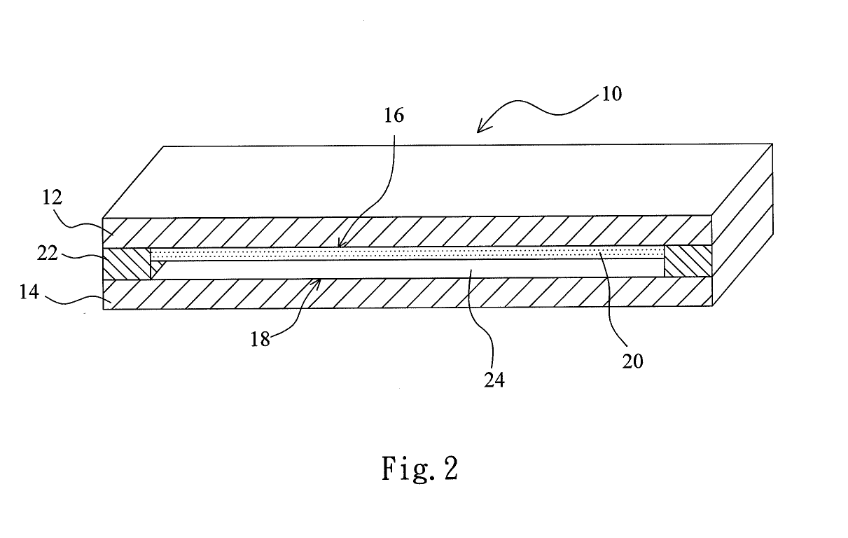

FIG. 1 is a schematic diagram of a plane structure of polymeric dispersed liquid crystal film according to a first embodiment of the present invention. FIG. 2 is a partial cross section schematic diagram of a plane structure of polymeric dispersed liquid crystal film according to the first embodiment of the present invention. As shown in FIG. 1 and FIG. 2, a plane structure of polymeric dispersed liquid crystal film 10 comprises two transparent rigid substrates, which are the first transparent rigid substrate 12 and the second transparent rigid substrate 14. The first transparent rigid substrate 12 and the second transparent rigid substrate 14 are arranged parallel and separately, and respectively have the first inner face 16 and the second inner face 18 which are positioned oppositely. According to this embodiment, the first transparent rigid substrate 12 and the second transparent rigid substrate 14 are in the shape of plate but not limited to the shape described above. The first and the second transparent rigid substrate 12 and 14 may also be in the form of curved face; a PDLC light shuffle film 20 is arranged on the first inner face 16 of the first transparent rigid substrate 12. According to one embodiment, the PDLC light film 20 is fixed with an adhesive gel on the first inner face 16; and a first sealed structure 22, which is arranged on the periphery between the first inner face 16 and the second inner face 18, for sealing the gap between the first transparent rigid substrate 12 and the second transparent substrate 14 so as to form a hollow space 24 between the first transparent rigid substrate 12 and the second transparent substrate 14.

Wherein, the PDLC light shuffle film 20 is a polymeric dispersed liquid crystal, which is arranged between two parallel substrates with transparent conductive electrodes (not shown). Under the low driving voltage of the transparent conductive electrodes, the PDLC light shuffle film 20 changes from strong-scattering opaque state to clean transparent state. When the voltage is removed (i.e. natural condition), the PDLC light shuffle film 20 will change from clean transparent state to strong-scattering opaque state.

Continuing the above description, the first transparent rigid substrate 12 and the second transparent rigid substrate 14 are made from glass, Poly Carbonate, plastic, laminated glass or gluing plastic. Further, the first sealed structure 22 is made from Polyvinyl Butyral (PVB), ethylene naphthalate (EN), Polyethylene Naphthalate (PEN), Ethylvinyl Acetate (EVA), poly urethane (PU), thermoplastic poly urethane (TPU) or adhesive gel but not limited to materials described above. The first sealed structure 22 is a hollow and insulation design between the first transparent rigid structure 12 and the second transparent 14 as an air spacer. According to an embodiment, a hollow space can be filled with dry air or inert gas and so on according to different needs.

Continuing the above description, the plane structure of polymeric dispersed liquid crystal film 10 is can be applied to doors and windows, glass curtain walls, greenhouses, screen partitions, and partition walls for construction industry or showcases for furniture industry. Because of the hollow and insulation design of air spacer between the PDLC light shuffle film 20 and the second transparent rigid substrate 14, the plane structure 10 is capable of thermal insulation and soundproofing and is a kind of ideal energy-saving building material. Wherein, if the first hollow space 24 is filled with dry air, it is capable of vapor resistance; if filled with inert gas such as argon and so on, it is capable of better thermal insulation. The PDLC light shuffle film 20 is arranged between the first and the second transparent rigid substrates 12 and 14. By changing driving voltage, transparency of the plane structure 10 can be adjusted wholly so as to change transparency of the plane structure 10 freely. For example, when the PDCL light shuffle film is in strong-scattering opaque state, the plane structure 10 will act as ground glass; when the PDLC light shuffle film is in clean transparent state, the plane structure appears transparent.

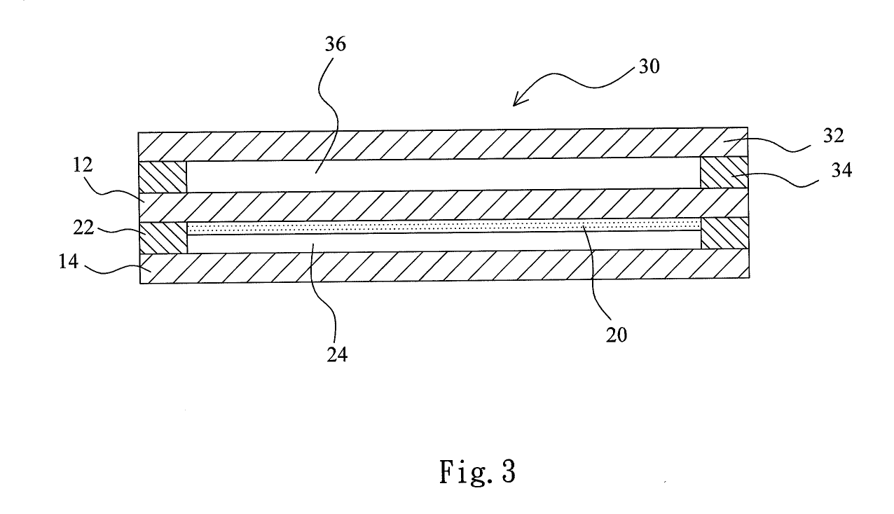

FIG. 3 shows a cross section schematic diagram of a plane structure of polymeric dispersed liquid crystal film according to a second embodiment of the present invention. As shown in the figure, the difference with the first embodiment is that the plane structure 30 further comprises a third transparent rigid substrate 32, which is separately arranged with the first transparent rigid substrate 12, and a second sealed structure 34 is arranged on the periphery between the first transparent rigid substrate 12 and the third transparent rigid substrate 32 for forming a second sealed hollow space 36. The second hollow space 36 can be filled with dry air or inert gas and so on, wherein the gas filled can be the same as the gas filled in the hollow space 24 or not. Materials of the third transparent rigid substrate 32 and the second sealed structure 34 are disclosed in the description of the first transparent rigid substrate 12 and the first sealed structure 22 according to the first embodiment and will not be elaborated any further here. According to the second embodiment, a third transparent rigid substrate 32 is added to increase thickness of the plane structure so as to promote thermal insulation and soundproofing effects. It should be understood that the invention is not limited to the embodiment disclosed, for example, a layer or more transparent rigid substrates can be added and space between the substrates is hollow and insulated.

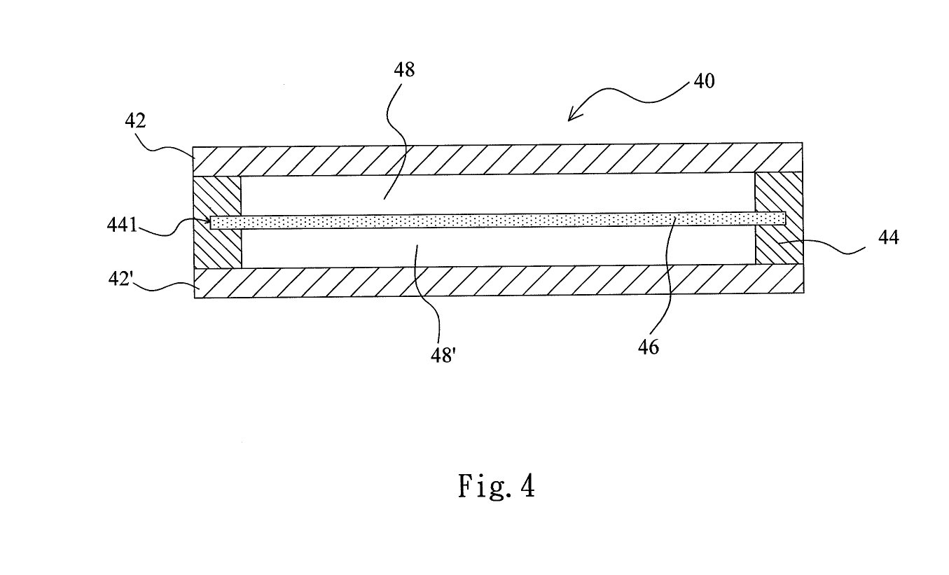

FIG. 4 shows a cross section schematic diagram of a plane structure of polymeric dispersed liquid crystal film according to a third embodiment of the present invention. As shown in the figure, a plane structure of polymeric dispersed liquid crystal film 40 comprises: two separately arranged transparent rigid substrates 42 and 42′; a sealed structure 44 arranged on the periphery between the two transparent rigid substrates 42 and 42′, wherein the opposite inner surfaces of the sealed structure 44 forming a groove 441; and a PDLC light shuffle film 46, whereof the sides are arranged inside the groove 441 and thereby arranging the PDCL light shuffle film between two transparent rigid substrates 42 and 42′. Wherein, whole sides of the PDLC light shuffle film 46 can be arranged inside the groove 441 of the sealed structure 44 otherwise only two opposite sides of the PDLC light shuffle film 46 are arranged inside the groove 441 of the sealed structure 44. According to the third embodiment, the PDCL light shuffle film 46 is arranged between the two transparent rigid substrates 42 and 42′. By changing driving voltage, transparency of the plane structure 40 can be adjusted so as to change transparency of the plane structure 40 freely. Hollow space 48 and 48′ can be formed respectively between the PDLC light shuffle film 46 and the two transparent rigid substrates 42 and 42′, wherein different or same gases can be filled to achieve better thermal insulation, soundproofing and vapor resistance effects.

According to the aforementioned description, the plane structure of polymeric dispersed liquid crystal film can change its transparency freely with the advantages of blocking sight from viewers outside and protecting privacy. Wherein, the hollow and insulation design between the PDLC light shuffle film and the transparent rigid substrate or between two transparent rigid substrates make the plane structure better thermal-insulated. In addition to higher safety, a constant temperature environment can be formed indoors to efficiently reduce expenditure on air conditioning with the advantages of energy saving. Furthermore, effect of vapor resistance is good because dry air is filled into the hollow space, which can be applied to construct outside wall in the circumstance with greater temperature difference between indoor and outdoor.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A plane structure of polymeric dispersed liquid crystal film comprising:
two separately arranged transparent rigid substrates, which are the first transparent rigid substrate and the second transparent rigid substrate, wherein the first transparent rigid substrate and the second transparent rigid substrate respectively have a first inner surface and a second inner surface opposite to each other;
a polymeric dispersed liquid crystal light shuffle film, arranged on the first inner surface; and
a first sealed structure, arranged on the periphery between the first inner surface and the second inner surface, for forming a first hollow space between the first transparent rigid substrate and the second transparent rigid substrate.

2. The plane structure of polymeric dispersed liquid crystal film according to claim 1, wherein the first hollow space is filled with a gas.

3. The plane structure of polymeric dispersed liquid crystal film according to claim 1, wherein the two transparent rigid substrates are made from glass, Poly Carbonate, plastic, laminated glass or gluing plastic.

4. The plane structure of polymeric dispersed liquid crystal film according to claim 1, wherein the first sealed structure are made from Polyvinyl Butyral (PVB), ethylene naphthalate (EN), Polyethyle Naphthalate (PEN), Ethyl Vinyl Acetate (EVA), poly urethane (PU), thermoplastic poly urethane (TPU) or adhesive gel.

5. The plane structure of polymeric dispersed liquid crystal film according to claim 1, wherein the polymeric dispersed liquid crystal light shuffle is polymeric dispersed liquid crystal arranged between two substrates with transparent conductive electrodes.

6. A plane structure of polymeric dispersed liquid crystal film according to claim 1, wherein the first sealed structure is an air spacer.

7. The plane structure of polymeric dispersed liquid crystal film according to claim 1, wherein the polymeric dispersed liquid crystal light shuffle film is fixed on the first inner face with adhesive gel.

8. The plane structure of polymeric dispersed liquid crystal film according to claim 1 further comprising:
a third transparent rigid substrate, separately arranged with the first transparent rigid substrate; and
a second sealed structure, arranged on the periphery between the first transparent rigid substrate and the third transparent, for forming a second hollow space between the first transparent rigid substrate and the third transparent rigid substrate.

9. The plane structure of polymeric dispersed liquid crystal film according to claim 8, wherein the second sealed structure is an air spacer.

10. A plane structure of polymeric dispersed liquid crystal film comprising:
two separately arranged transparent rigid substrates;
a polymeric dispersed liquid crystal light shuffle film is arranged on the periphery between the two transparent rigid substrates, wherein at least two opposite inner surfaces of the sealed structure are forming a groove; and
a polymeric dispersed liquid crystal light shuffle film arranged between the two transparent rigid substrates.

11. The plane structure of polymeric dispersed liquid crystal film according to claim 10, wherein a sealed hollow space is formed between the two transparent rigid substrates and the polymeric dispersed liquid crystal light shuffle film.

12. The plane structure of polymeric dispersed liquid crystal film according to claim 10, wherein the hollow space is filled with a gas.

13. The plane structure of polymeric dispersed liquid crystal film according to claim 10, wherein the two transparent rigid substrates are made from glass, Poly Carbonate, plastic, laminated glass or gluing plastic.

14. The plane structure of polymeric dispersed liquid crystal film according to claim 10, wherein the sealed structure is an air spacer.

15. The plane structure of polymeric dispersed liquid crystal film according to the claim 10, wherein the two transparent rigid substrates are made from polyvinyl Butyral (PVB), ethylene naphthalate (EN), Polyethyle Naphthalate (PEN), Ethyl Vinyl Acetate (EVA), poly urethane (PU), thermoplastic poly urethane (TPU) or adhesive gel.

16. The plane structure of polymeric dispersed liquid crystal film according to claim 10, wherein the polymeric dispersed liquid crystal light shuffle film is polymeric dispersed liquid crystal arranged between two substrates with transparent conductive electrodes.
